(19) United States
(12) Patent Application Publication
(10) Pub. No.: US 2026/0245339 A1
(43) Pub. Date: Aug. 20, 2026

(54) METHOD FOR GENERATING OBJECT SET AND IMAGE, ELECTRONIC DEVICE AND STORAGE MEDIUM

(71) Applicant: MOORE THREADS TECHNOLOGY CO., LTD., Beijing (CN)

(72) Inventor: Honglun ZHANG, Beijing (CN)

(21) Appl. No.: 19/489,527

(22) PCT Filed: Feb. 28, 2024
(86) PCT No.: PCT/CN2024/079011

§ 371 Date: Dec. 2, 2025

(30) Foreign Application Priority Data
Jun. 6, 2023 (CN) 202310664959.4

(51) Int. Cl. G06V 10/74; G06F 16/583; G06T 11/00

(52) U.S. Cl. CPC G06V 10/761; G06F 16/583; G06T 11/00

(57) ABSTRACT

The present disclosure relates to the technical field of computers, and provided thereby are an object set and image generation method and apparatus, an electronic device, a storage medium, a computer program, and a computer program product. The object set and image generation method comprises: on the basis of a prompt information set, determining a first image set; for each candidate object in a candidate object set, on the basis of the candidate object and the prompt information set, determining a second image set that matches the candidate object, the candidate object being used for representing an image style; and on the basis of attribute information of the first image set and attribute information of the second image set corresponding to each candidate object, determining a first object set from the candidate object set.

### CROSS-REFERENCE TO RELATED APPLICATION

This application is based on and claims priority to Chinese Patent Application No. 202310664959.4 filed on Jun. 6, 2023 and entitled “OBJECT SET AND IMAGE GENERATION METHOD AND APPARATUS, ELECTRONIC DEVICE AND STORAGE MEDIUM”, the entire content of which is hereby incorporated by reference in its entirety.

### TECHNICAL FIELD

The present disclosure relates to, but is not limited to, the technical field of computer, and in particular to an object set and image generation method and apparatus, an electronic device, a storage medium, a computer program, and a computer program product.

### BACKGROUND

Text-to-Image Generation, as an important part of Artificial Intelligence Generated Content (AIGC), is receiving increasing attention and application. In implementation, a user only needs to describe expected content through text (i.e., a prompt), and a generation model may generate a high-quality image that meets semantic requirements.

In related technologies, by adding an object (e.g., an artist name, a celebrity name, etc.) to the prompt, the generation model may generate an image with a style and content matching the object, so as to achieve the purpose of improving image generation effects. However, these objects are typically obtained by relying on personal perceptual judgment, community experience, manual organization, etc., which have problems such as limited quantity, low accuracy and low efficiency, thereby causing limitations, instability, unexplainability and other issues in the generation results.

### SUMMARY

Embodiments of the present disclosure provide an object set and image generation method and apparatus, an electronic device, a storage medium, a computer program and a computer program product.

The technical solutions of the embodiments of the present disclosure are implemented as follows.

An embodiment of the present disclosure provides a method for generating an object set. The method is performed by an electronic device. The method for generating the object set includes the following operations.

A first image set is determined based on a prompt information set. Each first image in the first image set corresponds to a respective piece of first prompt information in the prompt information set.

For each candidate object in a candidate object set, a second image set matching the candidate object is determined based on the candidate object and the prompt information set. The second image set includes at least one second image. Each of the at least one second image corresponds to a respective piece of first prompt information. The candidate object is configured to characterize an image style.

A first object set is determined from the candidate object set based on attribute information of the first image set and attribute information of a respective second image set corresponding to each candidate object.

An embodiment of the present disclosure provides a method for generating an image. The method is performed by an electronic device. The method for generating the image includes the following operations.

At least one target object is determined from a second object set. The second object set is obtained according to any one of the above-mentioned methods for generating the object set.

An image corresponding to prompt information is generated based on the prompt information and each of the at least one target object.

An embodiment of the present disclosure provides an apparatus for generating an object set, which includes a first determining part, a second determining part and a first generating part.

The first determining part is configured to determine a first image set based on a prompt information set. Each first image in the first image set corresponds to a respective piece of first prompt information in the prompt information set.

The second determining part is configured to, for each candidate object in a candidate object set, determine a second image set matching the candidate object based on the candidate object and the prompt information set. The second image set includes at least one second image. Each of the at least one second image corresponds to a respective piece of first prompt information. The candidate object is configured to characterize an image style.

The first generating part is configured to determine a first object set from the candidate object set based on attribute information of the first image set and attribute information of a respective second image set corresponding to each candidate object.

An embodiment of the present disclosure provides an apparatus for generating an image, which includes a third determining part and a second generating part.

The third determining part is configured to determine at least one target object from a second object set. The second object set is obtained according to any one of the above-mentioned methods for generating the object set.

The second generating part is configured to generate an image corresponding to prompt information based on the prompt information and each of the at least one target object.

An embodiment of the present disclosure provides an electronic device, which includes a processor and a memory. The memory is configured to store a computer program executable on the processor, and the processor is configured to execute the computer program to implement the above-mentioned methods.

An embodiment of the present disclosure provides a computer-readable storage medium having stored thereon a computer program, which, when executed by a processor, implements the above-mentioned methods.

An embodiment of the present disclosure provides a computer program including a computer-readable code. When the computer-readable code is run in a computer device, a processor in the computer device is configured to implement some or all operations of the above-mentioned methods.

An embodiment of the present disclosure provides a computer program product. The computer program product includes a non-transitory computer-readable storage medium having stored thereon a computer program, which, when read and executed by a computer, implements the above-mentioned methods.

In the embodiments of the present disclosure, a first image set is determined based on a prompt information set. Each first image in the first image set corresponds to a respective piece of first prompt information in the prompt information set. For each candidate object in a candidate object set, a second image set matching the candidate object is determined based on the candidate object and the prompt information set. The second image set includes at least one second image. Each of the at least one second image corresponds to a respective piece of first prompt information. The candidate object is configured to characterize an image style. A first object set is determined from the candidate object set based on attribute information of the first image set and attribute information of a respective second image set corresponding to each candidate object. In this way, by using the attribute information of the first image set and attribute information of a respective second image set corresponding to each candidate object, the candidate object set is automatically screened to obtain the first object set. Compared with methods such as personal perceptual judgment, community experience and manual organization, the quantity of objects increases and the time required to obtain the objects is shortened, so that the cost of obtaining the objects is reduced. In addition, the reliability and accuracy of the obtained objects are improved. Furthermore, subsequently generating images using the first object set enables the images to have richer and more diverse enhancement effects, thereby reducing the limitations of using only a small number of manually experienced objects to enhance generated images, and reducing the possibility of instability and unexplainability that may result from blindly using a large number of unverified objects.

It should be understood that the above general description and the following detailed description are exemplary and explanatory only, and are not restrictive of the present disclosure.

### BRIEF DESCRIPTION OF THE DRAWINGS

The drawings herein are incorporated into and constitute a part of the specification. These drawings illustrate embodiments consistent with the present disclosure and are used together with the specification to explain the technical solutions of the present disclosure.

FIG. 1 is a first schematic diagram of an implementation process of a method for generating an object set according to an embodiment of the present disclosure.

FIG. 2 is a second schematic diagram of an implementation process of a method for generating an object set according to an embodiment of the present disclosure.

FIG. 3 is a first schematic diagram of an implementation process of a method for generating an image according to an embodiment of the present disclosure.

FIG. 4A is a third schematic diagram of an implementation process of a method for generating an object set according to an embodiment of the present disclosure.

FIG. 4B is a schematic diagram of an aesthetic score value of an image according to an embodiment of the present disclosure.

FIG. 4C is a second schematic diagram of an implementation process of a method for generating an image according to an embodiment of the present disclosure.

FIG. 4D is a schematic diagram of an image generated based on a prompt according to an embodiment of the present disclosure.

FIG. 5 is a structural diagram of an apparatus for generating an object set according to an embodiment of the present disclosure.

FIG. 6 is a structural diagram of an apparatus for generating an image according to an embodiment of the present disclosure.

FIG. 7 is a schematic diagram of a hardware entity of an electronic device according to an embodiment of the present disclosure.

### DETAILED DESCRIPTION

To make the objectives, technical solutions, and advantages of the present disclosure clearer, the present disclosure will be further described in detail below with reference to the accompanying drawings. The described embodiments should not be considered as limiting the present disclosure. All other embodiments obtained by those skilled in the art without creative efforts shall fall within the scope of protection of the present disclosure.

In the following description, reference is made to “some embodiments,” which describes a subset of all possible embodiments. However, it may be understood that “some embodiments” may be the same subset or different subsets of all possible embodiments and may be combined with each other without conflict.

In the following description, the involved terms “first second third” are used to distinguish similar objects and do not indicate a specific order of the objects. It may be understood that the terms “first second\third” may be interchanged in a specific order or sequence where allowed, so that the embodiments of the present disclosure described herein may be implemented in an order other than that illustrated or described herein.

Unless otherwise defined, all technical and scientific terms used herein have the same meanings as those commonly understood by those skilled in the technical field of the present disclosure. The terms used herein are for the purpose of describing the embodiments of the present disclosure only and are not intended to limit the present disclosure.

In related technologies, users with certain experience often add some commonly used objects when composing prompts, so that the generation model correspondingly generates styles and contents similar to those of the objects, thereby achieving the purpose of improving the generation effect. However, relying mainly on community experience and manual organization results in a very limited number of objects. In the process of text-to-image generation, repeatedly using these few objects, while improving the generation effect, seriously affects the diversity of the generation results. At the same time, some online text-to-image websites provide more objects for users to use, but the users are not familiar with the style and content of each object. Blind selection may instead make the generation results not as expected, bringing instability and unexplainability.

The embodiments of the present disclosure provide a method for generating an object set. By using the attribute information of the first image set and the attribute information of a respective second image set corresponding to each candidate object, the candidate object set is automatically screened to obtain the first object set. Compared with methods such as personal perceptual judgment, community experience and manual organization, the quantity of objects increases and the time required to obtain the objects is shortened, so that the cost of obtaining the objects is reduced. In addition, the reliability and accuracy of the obtained objects are improved. Furthermore, subsequently generating images using the first object set enables the images to have richer and more diverse enhancement effects, thereby reducing the limitations of using only a small number of manually experienced objects to enhance generated images, and reducing the possibility of instability and unexplainability that may result from blindly using a large number of unverified objects. The method provided by the embodiments of the present disclosure may be executed by an electronic device. The electronic device may be various types of terminals such as a laptop, a tablet computer, a desktop computer, a set-top box, a mobile device (e.g., a mobile phone, a portable music player, a personal digital assistant, a dedicated messaging device, a portable gaming device), or may be implemented as a server. The server may be an independent physical server, a server cluster or distributed system composed of multiple physical servers, or a cloud server that provides cloud services, cloud databases, cloud computing, cloud functions, cloud storage, network services, cloud communication, middleware services, domain name services, security services, Content Delivery Network (CDN), and big data and artificial intelligence platforms.

The technical solutions of the embodiments of the present disclosure will be clearly and completely described below with reference to the accompanying drawings in the embodiments of the present disclosure.

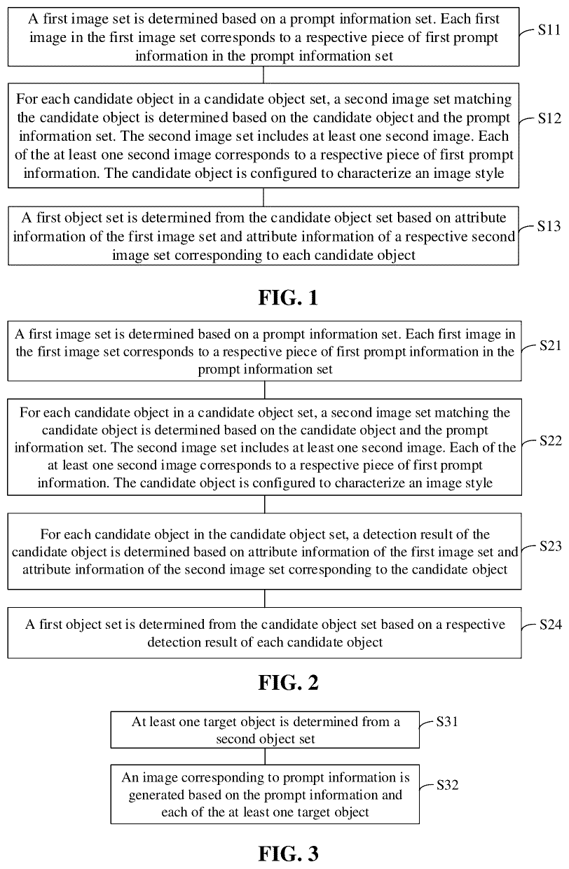

FIG. 1 is a first schematic diagram of an implementation process of a method for generating an object set according to an embodiment of the present disclosure. As shown in FIG. 1, the method includes operations S11 to S13.

At S11, a first image set is determined based on a prompt information set. Each first image in the first image set corresponds to a respective piece of first prompt information in the prompt information set.

Here, the prompt information set includes at least one piece of first prompt information. The first prompt information may be any suitable prompt information. In implementation, the first prompt information may be text prompt information, voice prompt information, etc. For example, the first prompt information may be text/voice prompt information describing attribute information of a person, a virtual object, an item, etc. The attribute information may include, but is not limited to, gender (e.g., male, female), body type (e.g., tall, short, fat, thin, etc.), appearance, etc. The virtual object may be a model, a digital human, etc. For example, the first prompt information may be “a beautiful girl”. For another example, the first prompt information may be “a student riding a bicycle”.

The manner of obtaining the first prompt information set may be determined according to the actual application scenario, which is not limited in the embodiments of the present disclosure.

For example, the user input the prompt information set through an input component of the electronic device. The input component may include, but is not limited to, a keyboard, a mouse, a touch screen, a touchpad, an audio input device, etc.

For another example, a prompt information set sent by another device is received.

For still another example, multiple pieces of prompt information are selected from a second prompt information set as the first prompt information set according to a preset selection rule. The selection rule may include, but is not limited to, default configuration of the electronic device, random selection, user customization, user preference, frequency of use, application scenario, user operation information, etc. In implementation, those skilled in the art may set the selection rule independently according to actual requirements, which is not limited in the present disclosure. For example, the first 100 pieces of prompt information in the second prompt information set are taken as the first prompt information set. For another example, 80 pieces of prompt information are randomly selected from the second prompt information set as the first prompt information set. For still another example, the first prompt information set is selected from the second prompt information set in real time according to a user's gesture. For example, different gestures/operation step lengths correspond to different prompt information sets. For instance, when the user inputs a first gesture, the first 100 pieces of prompt information are taken as the first prompt information set. When the user inputs a second gesture, 100 pieces of prompt information are randomly selected as the first prompt information set.

The second prompt information set is a prompt information set obtained by preprocessing other prompt information sets. The other prompt information sets may be obtained from multiple prompt records that are acquired from some associated links (e.g., text-to-image links, prompt resource links) using techniques such as web crawling. In implementation, the prompt records may include, but are not limited to, prompt identifiers, prompts, attribute information of generated images, random numbers, etc. That is, the prompt in each prompt record is taken as a piece of prompt information in the other prompt information sets. The preprocessing may include, but is not limited to, deduplication, length screening, named entity recognition, etc. For example, deduplication is performed on multiple prompts, i.e., for N identical prompts, only one prompt is retained, and the remaining N−1 prompts are deleted, where N is a positive integer greater than 1. For another example, the length of each prompt is counted, and prompts that are too long or too short are deleted. For still another example, each prompt is detected by using a preset named entity recognition model. If the prompt is a preset name, the prompt is retained. Otherwise, the prompt is deleted. The preset name may include, but are not limited to, names of persons, names of virtual objects, etc. In this way, by extracting the second prompt information set from a large number of prompt records, richer and more diverse enhancement effects can be achieved for the text-to-image generation.

The number of first images in the first image set is the same as the number of pieces of first prompt information in the first prompt information set. That is, if the first prompt information set includes M pieces of first prompt information, the first image set includes M images, and M is a positive integer.

In some embodiments, for each piece of first prompt information in the first prompt information set, a preset text-to-image generation model is used to generate a first image corresponding to the first prompt information. The text-to-image generation model may be any suitable model capable of generating an image based on the prompt information. For example, the text-to-image generation model may be Stable Diffusion, Guided Language to Image Diffusion for Generation and Editing (GLIDE), Midjourney, MUSE, etc.

At S12, for each candidate object in a candidate object set, a second image set matching the candidate object is determined based on the candidate object and the prompt information set. The second image set includes at least one second image. Each of the at least one second image corresponds to a respective piece of first prompt information. The candidate object is configured to characterize an image style.

Here, the candidate object set includes at least one candidate object. The candidate object may be any suitable object. For example, the candidate object may be an artist name, a celebrity name, identifier information of a virtual object, etc. (e.g., illustrator Artgerm, Avatar, Spider-Man, etc.).

The second image set at least includes each second image. The number of second images is the same as the number of pieces of first prompt information. That is, if the number of first prompt information is X, the number of second images is X, and X is a positive integer.

In some embodiments, the operation that “at least one second image with a style matching the candidate object is determined based on the candidate object and each piece of first prompt information” in the operation S12 may include an operation S121.

At S121, for each piece of first prompt information in the prompt information set, second prompt information is determined based on the candidate object and the first prompt information, and a second image matching the candidate object is determined based on the second prompt information.

Here, the second prompt information may be a combination of the first prompt information and the candidate object in a random order. For example, if the first prompt information is “a beautiful girl” and the candidate object is the illustrator “artgerm”, the second prompt information may be “a beautiful girl, artgerm” or “artgerm, a beautiful girl”.

In some embodiments, the manner of determining the second image is similar to that of determining the first image in the above-mentioned operation S11. In implementation, reference may be made to the specific implementation of the operation S11.

At S13, a first object set is determined from the candidate object set based on attribute information of the first image set and attribute information of a respective second image set corresponding to each candidate object.

Here, by comparing the attribute information of the first image set with the attribute information of each second image set, each candidate object in the candidate object set is screened, and the candidate object set after the screening is taken as the first object set. The number of candidate objects in the first object set is not greater than the number of candidate objects in the candidate object set. For example, if the candidate object set includes N candidate objects, after the screening, the first object set includes only M (M≤N) candidate objects.

The attribute information of an image set may include, but is not limited to, a score value, a cross-modal similarity, etc. The score value is used to evaluate the artistic expression, appeal, beauty, etc. of an image. The cross-modal similarity is used to measure the similarity between the image and the text (i.e., prompt information).

For example, in a case that a first score value of the first image set and a second score value of the second image set satisfy a first preset condition, it is indicated that after using the candidate object, the artistic expression, appeal, beauty, etc. of the image do not increase but decrease, so the candidate object needs to be deleted. Otherwise, the candidate object is taken as a candidate object in the first object set. The first preset condition may include, but is not limited to, a difference between the first score value and the second score value being less than a preset score threshold, the second score value being less than the first score value, and the like.

For another example, in a case that a second cross-modal similarity of the second image set and a first cross-modal similarity of the first image set satisfy a second preset condition, it is indicated that after using the candidate object, the cross-modal similarity of the image does not increase but decrease, and the generated image is more semantically inconsistent with the original prompt information (corresponding to the above-mentioned first prompt information), so the candidate object needs to be deleted. Otherwise, the candidate object is taken as a candidate object in the first object set. The second preset condition may include, but is not limited to, a difference between the first cross-modal similarity and the second cross-modal similarity being less than a preset similarity threshold, the second cross-modal similarity being less than the first cross-modal similarity, and the like.

The manner of determining the score of an image set may include, but is not limited to, the score of a certain image in the image set, weighting/taking logarithm/taking exponent of the score of a certain image, the mean/mean square error/variance of the scores of images in the image set, the mean/mean square error/variance after weighting the scores of images in the image set, etc. In implementation, those skilled in the art may independently select the manner of determining the score of the image set according to actual requirements, which is not limited in the embodiments of the present disclosure. For example, the mean of the scores of images in the image set may be taken as the score of the image set.

The manner of determining the cross-modal similarity of an image set may include, but is not limited to, the cross-modal similarity of a certain image in the image set, weighting/taking logarithm/taking exponent of the cross-modal similarity of a certain image, the mean/mean square error/variance of the cross-modal similarities of images in the image set, the mean/mean square error/variance after weighting the cross-modal similarities of images in the image set, etc. In implementation, those skilled in the art may independently select the manner of determining the cross-modal similarity of the image set according to actual requirements, which is not limited in the embodiments of the present disclosure. For example, the mean of the cross-modal similarities of images in the image set may be taken as the cross-modal similarity of the image set.

In the embodiments of the present disclosure, by using the first image set and the second image set corresponding to each candidate object, the candidate object set is automatically screened to obtain the first object set. Compared with methods such as personal perceptual judgment, community experience and manual organization, the quantity of objects increases and the time required to obtain the objects is shortened, so that the cost of obtaining the objects is reduced. In addition, the reliability and accuracy of the obtained objects are improved. Furthermore, subsequently generating images using the first object set enables the images to have richer and more diverse enhancement effects, thereby reducing the limitations of using only a small number of manually experienced objects to enhance generated images, and reducing the possibility of instability and unexplainability that may result from blindly using a large number of unverified objects.

FIG. 2 is a second schematic diagram of an implementation process of a method for generating an object set according to an embodiment of the present disclosure. As shown in FIG. 2, the method includes operations S21 to S24.

At S21, a first image set is determined based on a prompt information set. Each first image in the first image set corresponds to a respective piece of first prompt information in the prompt information set.

At S22, for each candidate object in a candidate object set, a second image set matching the candidate object is determined based on the candidate object and the prompt information set. The second image set includes at least one second image. Each of the at least one second image corresponds to a respective piece of first prompt information. The candidate object is configured to characterize an image style.

Here, the above-mentioned operations S21 to S22 correspond to the above-mentioned operations S11 to S12, respectively, and may be implemented with reference to the implementations of the operations S11 to S12.

At S23, for each candidate object in the candidate object set, a detection result of the candidate object is determined based on attribute information of the first image set and attribute information of the second image set corresponding to the candidate object.

Here, the detection result of the candidate object indicates whether the candidate object needs to be deleted from the candidate object set. In some embodiments, the detection result includes a first detection result and a second detection result. The first detection result indicates that the candidate object needs to be deleted from the candidate object set, and the second detection result indicates that the candidate object does not need to be deleted from the candidate object set.

In some embodiments, the attribute information of the first image set and the attribute information of the second image set corresponding to the candidate object may be compared to obtain the detection result of the candidate object. The attribute information of the image set may include, but is not limited to, a score, a cross-modal similarity, etc.

For example, in a case that a first score value of the first image set and a second score value of the second image set satisfy the above-mentioned first preset condition, the first detection result is taken as the detection result of the candidate object. Otherwise, the second detection result is taken as the detection result of the candidate object.

For another example, in a case that a second cross-modal similarity of the second image set and a first cross-modal similarity of the first image set satisfy the above-mentioned second preset condition, the first detection result is taken as the detection result of the candidate object. Otherwise, the second detection result is taken as the detection result of the candidate object.

At S24, a first object set is determined from the candidate object set based on a respective detection result of each candidate object.

Here, if the detection result of each candidate object is the second detection result, the candidate object set is taken as the first object set. Otherwise, if at least one candidate object has the first detection result, each candidate object corresponding to the first detection result is deleted from the candidate object set, and the candidate object set subject to the deletion is taken as a new candidate object set. Operations S21 to S24 are executed again cyclically until the detection result of each candidate object in the new candidate object set is the second detection result.

In some embodiments, the operation S24 includes at least one of operation S241 and operation S242.

At S241, in a case that a respective detection result of each candidate object is a second detection result, the candidate object set is taken as the first object set.

Here, the detection result of each candidate object indicates that the corresponding candidate object does not need to be deleted from the candidate object set, which indicates that no candidate object in the candidate object set needs to be deleted in this round of optimization, and a final effective, reliable and high-quality candidate object set is obtained.

At S242, in a case that detection results of candidate objects include at least one first detection result, a respective candidate object corresponding to each of the at least one first detection result is deleted from the candidate object set, and the candidate object set subject to the deletion is taken as a new candidate object set. A new first image set is determined based on a new prompt information set. For each candidate object in the new candidate object set, a new second image set matching the candidate object is determined based on the new prompt information set and the candidate object. The first object set is determined from the new candidate object set based on attribute information of the new first image set and attribute information of a respective new second image set corresponding to each candidate object.

Here, in a case that the detection results of the candidate objects include at least one first detection result, it is indicated that some candidate objects in the candidate object set need to be deleted in this round of optimization, and further optimization of the candidate object set is required to obtain a final effective, reliable, and high-quality candidate object set. In implementation, the implementation that “a new first image set is determined based on a new prompt information set. For each candidate object in the new candidate object set, a new second image set matching the candidate object is determined based on the new prompt information set and the candidate object. The first object set is determined from the new candidate object set based on attribute information of the new first image set and attribute information of a respective new second image set corresponding to each candidate object” in the operation S242 may refer to the implementations of the operations S11 to S13.

In the embodiments of the present disclosure, on one hand, the detection result of each candidate object is determined by using the attribute information of the first image set and the attribute information of the second image set corresponding to each candidate object, so that the accuracy of the detection result is improved, thereby providing data support for subsequent screening of candidate objects. On the other hand, the candidate object set is optimized according to each detection result. Compared with methods such as personal perceptual judgment, community experience and manual organization, the optimization time can be shortened and the optimization efficiency can be improved, thereby reducing optimization costs and providing reliable and accurate data support for subsequent text-to-image generation.

In some embodiments, the attribute information of the first image set includes a first score value, and the attribute information of the second image set includes a second score value. The operation that “the detection result of the candidate object is determined based on the attribute information of the first image set and the attribute information of the second image set corresponding to the candidate object” in the operation S23 may include the operations S231 to S233.

At S231, the first score value of the first image set is determined based on a respective score value of each first image in the first image set.

Here, the score value of the first image may be obtained through any suitable scoring model, algorithm, etc. For example, the scoring model includes neural networks such as Visual Geometry Group Network (VGGNet), Resnet, LeNet, Single Shot MultiBox Detector (SSD), etc. For another example, a Neural Image Assessment (NIMA) algorithm is used for the aesthetic scoring of images. For still another example, an aesthetic scoring model trained based on a Simulacra Aesthetic Captions (SAC) dataset uses a Contrastive Language-Image Pretraining (CLIP) model to extract image features, and after inputting the image features into a multi-layer linear network layer, outputs a score value between 1 and 10 as the aesthetic scoring result of the image. In implementation, the aesthetic scoring model can give aesthetic scoring results with discrimination for images of different qualities. The higher the score value, the higher the aesthetic value of the image. In implementation, those skilled in the art may independently select the manner of determining the score value of the first image according to actual requirements, which is not limited in the embodiments of the present disclosure.

The manner of determining the first score value may include, but is not limited to, the score value of a certain image in the first image set, weighting/taking logarithm/taking exponent of the score value of a certain image, the mean/mean square error/variance of the score values of images in the first image set, the mean/mean square error/variance after weighting the score values of images in the first image set, etc. In implementation, those skilled in the art may independently select the manner of determining the first score value according to actual requirements, which is not limited in the embodiments of the present disclosure. For example, the mean of the score values of images in the first image set is taken as the first score value.

At S232, the second score value of the second image set is determined based on a respective score value of each second image in the second image set.

Here, the manner of determining the score value of the second image is similar to that of determining the score value of the first image in the above-mentioned operation S231. In implementation, reference may be made to the implementation of the operation S231.

The manner of determining the second score value may include, but is not limited to, the score value of a certain image in the second image set, weighting/taking logarithm/taking exponent of the score value of a certain image, the mean/mean square error/variance of the score values of images in the second image set, the mean/mean square error/variance after weighting the score values of images in the second image set, etc. In implementation, those skilled in the art may independently select the manner of determining the second score value according to actual requirements, which is not limited in the embodiments of the present disclosure. For example, the mean of the score values of second images in the second image set is taken as the second score value.

At S233, the detection result of the candidate object is determined based on the first score value and the second score value.

Here, the first score value and the second score value may be compared to obtain the detection result of the candidate object. For example, if the first score value is greater than the second score value, it is indicated that after using the candidate object, the overall aesthetic score of the image does not increase but decrease, so the first detection result is taken as the detection result of the candidate object. Otherwise, the second detection result is taken as the detection result of the candidate object.

In some embodiments, the operation S233 may include at least one of operation S2331 and operation S2332.

At S2331, in a case that the second score value is less than the first score value, a first detection result is taken as the detection result of the candidate object.

Here, the first detection result indicates that the candidate object needs to be deleted from the candidate object set. For example, if the first score value is 7 and the second score value is 5, the second score value is less than the first score value, so the first detection result is taken as the detection result of the candidate object.

At S2332, in a case that the second score value is not less than the first score value, a second detection result is taken as the detection result of the candidate object.

Here, the second detection result indicates that the candidate object does not need to be deleted from the candidate object set. For example, if the first score value is 7 and the second score value is 8, the second score value is greater than the first score value, which indicates that after using the candidate object, the overall aesthetic score of the image is improved. Therefore, the second detection result is taken as the detection result of the candidate object.

In the embodiments of the present disclosure, the first score value of the first image set is determined based on a respective score value of each first image in the first image set. The second score value of the second image set is determined based on a respective score value of each second image in the second image set. The detection result of the candidate object is determined based on the first score value and the second score value. In this way, by comparing the score values of different image sets, the enhancement effect of the candidate object on the aesthetic quality of the text-to-image generation is quantitatively analyzed. Compared with relying on personal perceptual judgment, using quantifiable, comparable, and explainable evaluation criterias and screening criterias improves the accuracy and reliability of the detection results.

In some embodiments, the attribute information of the first image set includes a first cross-modal similarity, and the attribute information of the second image set includes a second cross-modal similarity. The operation that “the detection result of the candidate object is determined based on the attribute information of the first image set and the attribute information of the second image set corresponding to the candidate object” in the operation S23 may include operations S251 to S253.

At S251, the first cross-modal similarity corresponding to the first image set is determined based on each first image in the first image set and first prompt information corresponding to the each first image.

Here, the manner of determining the first cross-modal similarity may include, but is not limited to, the cross-modal similarity of a certain first image in the first image set, weighting/taking logarithm/taking exponent of the cross-modal similarity of a certain first image, the mean/mean square error/variance of the cross-modal similarities of first images in the first image set, the mean/mean square error/variance after weighting the cross-modal similarities of first images in the first image set, etc. The cross-modal similarity of the first image is obtained based on the first image and the first prompt information corresponding to the first image. In implementation, those skilled in the art may independently select the manner of determining the first cross-modal similarity according to actual requirements, which is not limited in the embodiments of the present disclosure. For example, the mean of the cross-modal similarities of first images in the first image set may be taken as the first cross-modal similarity.

In some embodiments, the operation S251 includes operations S2511 to S2512.

At S2511, for each first image in the first image set, a first similarity between the first image and the first prompt information corresponding to the first image is determined.

Here, the first similarity may be obtained through any suitable model, such as the CLIP, the Convolutional Neural Network (CNN) model, the Recurrent Neural Network (RNN) model, the Fully Neural Network (FNN) model, etc. In implementation, those skilled in the art may independently select the manner of determining the first similarity according to actual requirements, which is not limited in the embodiments of the present disclosure.

For example, through the CLIP, the first prompt information and the first image are mapped into a unified shared feature space, so that similar text and images have similar feature representations in this feature space. In implementation, both the first prompt information and the first image are mapped into fixed-length vector representations, and the first similarity between these two vector representations is calculated. The manner of calculating the first similarity may be any suitable calculation manner, such as a cosine distance, an inner product, a Euclidean distance, a Manhattan distance, a Pearson correlation coefficient, etc. In implementation, those skilled in the art may independently select the manner of calculating the similarity according to actual requirements, which is not limited in the embodiments of the present disclosure. For example, the cosine distance is used to calculate the first similarity between these two vector representations. The higher the first similarity, the higher the matching degree between the content of the image and the semantics of the prompt information.

At S2512, the first cross-modal similarity corresponding to the first image set is determined based on each first similarity.

Here, the manner of determining the first cross-modal similarity may include, but is not limited to, a certain first similarity, weighting/taking logarithm/taking exponent of a certain first similarity, the mean/mean square error/variance of the first similarities, the mean/mean square error/variance after weighting the first similarities, etc. For example, the mean of the first similarities is taken as the first cross-modal similarity.

At S252, the second cross-modal similarity corresponding to the second image set is determined based on each second image in the second image set and first prompt information corresponding to the each second image.

Here, the manner of determining the second cross-modal similarity is similar to that of determining the first cross-modal similarity in the above-mentioned operation S251. In implementation, reference may be made to the implementation of the operation S251.

In some embodiments, the operation S252 includes operations S2521 to S2522.

At S2521, for each second image in the second image set, a second similarity between the second image and the first prompt information corresponding to the second image is determined.

Here, the manner of determining the second similarity is similar to that of determining the first similarity in the above-mentioned operation S2511. In implementation, reference may be made to the implementation of the operation S2511.

At S2522, the second cross-modal similarity corresponding to the second image set is determined based on each second similarity.

Here, the manner of determining the second cross-modal similarity is similar to that of determining the first cross-modal similarity in the above-mentioned operation S2512. In implementation, reference may be made to the implementation of the operation S2512.

At S253, the detection result of the candidate object is determined based on the first cross-modal similarity and the second cross-modal similarity.

Here, the first cross-modal similarity and the second cross-modal similarity may be compared to obtain the detection result of the candidate object. For example, in a case that the first cross-modal similarity and the second cross-modal similarity satisfy the above-mentioned second preset condition, the first detection result is taken as the detection result of the candidate object. Otherwise, the second detection result is taken as the detection result of the candidate object.

In some embodiments, the operation S253 includes operations S2531 to S2533.

At S2531, a third cross-modal similarity is determined based on the first cross-modal similarity and the second cross-modal similarity.

Here, the manner of determining the third cross-modal similarity may include, but is not limited to, a first difference between the first cross-modal similarity and the second cross-modal similarity, weighting/taking exponent/taking logarithm of the first difference, a second difference obtained after weighting the first cross-modal similarity and the second cross-modal similarity respectively, weighting/taking exponent/taking logarithm of the second difference, etc. In implementation, those skilled in the art may independently select the manner of determining the third cross-modal similarity according to actual requirements, which is not limited in the embodiments of the present disclosure. For example, the first difference between the first cross-modal similarity and the second cross-modal similarity is taken as the third cross-modal similarity. For instance, if the first cross-modal similarity is C and the second cross-modal similarity is C_k, the third cross-modal similarity is (C_k−C).

At S2532, in a case that the third cross-modal similarity is less than a similarity threshold, a first detection result is taken as the detection result of the candidate object.

Here, the similarity threshold may be preset. In implementation, the similarity threshold may be an empirical value, a value obtained through multiple experiments, etc. In implementation, if (C_k−C) is less than δ (corresponding to the above-mentioned similarity threshold), it is indicated that after using the candidate object, the cross-modal similarity of the image does not increase but decrease, and the generated second image is more semantically inconsistent with the original prompt information. Therefore, the candidate object needs to be deleted, and the first detection result is taken as the detection result of the candidate object.

At S2533, in a case that the third cross-modal similarity is not less than the similarity threshold, a second detection result is taken as the detection result of the candidate object.

Here, if (C_k−C) is not less than δ, it is indicated that after using the candidate object, the cross-modal similarity of the image increases, and the generated second image is more semantically consistent with the original prompt information. Therefore, the candidate object needs to be retained, and the second detection result is taken as the detection result of the candidate object.

In the embodiments of the present disclosure, the first cross-modal similarity corresponding to the first image set is determined based on each first image in the first image set and first prompt information corresponding to the each first image. The second cross-modal similarity corresponding to the second image set is determined based on each second image in the second image set and first prompt information corresponding to the each second image. The detection result of the candidate object is determined based on the first cross-modal similarity and the second cross-modal similarity. In this way, by comparing the cross-modal similarities of different image sets, the effect of the candidate object on the semantics of the text-to-image generation is quantitatively analyzed. Compared with relying on personal perceptual judgment, using quantifiable, comparable and explainable evaluation criterias and screening criterias improves the accuracy and reliability of the detection results.

FIG. 3 is a first schematic diagram of an implementation process of a method for generating an image according to an embodiment of the present disclosure. As shown in FIG. 3, the method includes operations S31 to S32.

At S31, at least one target object is determined from a second object set.

Here, the second object set is obtained according to any one of the above-mentioned methods for generating an object set. There may be at least one target object. In implementation, the number of the target objects may be a random number, such as 1, 2, 3, etc.

The manner of determining the target object may include, but is not limited to, random selection, customization, user preference, frequency of use, user operation information, etc. In implementation, those skilled in the art may independently select the manner of determining the target object according to actual requirements, which is not limited in the present disclosure. For example, a random number (e.g., 2, 3, etc.) of target objects are randomly selected from the second object set. For another example, objects in the second image set are sorted according to frequency of use, and the top three objects with the highest frequency of use are taken as the target objects. For still another example, the target object is determined in real time according to a user's gesture. For instance, different gestures correspond to different target objects. That is, when the user inputs a first gesture, the first one of the objects in the second object set is taken as the target object. In implementation, the objects in the second object set may be sorted according to name, size, time (e.g., modification time, creation time, etc.), frequency of use, etc. When the user inputs a second gesture, the last two objects in the second object set are taken as the target objects. For another example, different operation step lengths correspond to different target objects. That is, when the operation step length falls within a first length range, the first three objects in the second object set are taken as the target objects. When the operation step length falls within a second length range, the last two objects in the second object set are taken as the target objects. The first length range and the second length range are different from each other. In implementation, those skilled in the art may independently set the correspondence between operation gestures, target objects, and the number of the target objects according to actual requirements, which is not limited in the embodiments of the present disclosure.

At S32, an image corresponding to prompt information is generated based on the prompt information and each of the at least one target object.

Here, the prompt information may be any suitable prompt information. In implementation, the prompt information may be text prompt information, voice prompt information, etc. For example, the prompt information may be text/voice prompt information describing attribute information of a person, a virtual object, an item, etc. For example, the prompt information may be “a tall and thin boy”. For another example, the prompt information may be “a girl wearing a necklace”. The manner of obtaining the prompt information may include, but is not limited to, inputting through an input component, receiving from another device, etc.

In implementation, the prompt information and each target object are combined in a random order to obtain third prompt information. The above-mentioned text-to-image generation model is used to generate a third image corresponding to the third prompt information, and the third image is taken as the image corresponding to the prompt information. For example, if the prompt information is “a beautiful girl” and the target objects include the illustrator “artgerm”, the Polish artist “greg rutkowski” and the artist “alphonse mucha”, the third prompt information may be “a beautiful girl, artgerm, greg rutkowski, alphonse mucha”, “a beautiful girl, greg rutkowski, artgerm, alphonse mucha”, “a beautiful girl, alphonse mucha, greg rutkowski, artgerm”, etc. In implementation, different third prompt information result in different enhancement effects of the generated images.

In the embodiments of the present disclosure, at least one target object is determined from a second object set, and an image corresponding to prompt information is generated based on the prompt information and each of the at least one target object. In this way, on one hand, due to the rich diversity of multiple objects in the second object set, compared with using only a few objects to generate the images, using the second image set to generate the images enables the images to have richer and more diverse enhancement effects, thereby reducing the limitations of using only a small number of manually experienced objects to enhance the generated images, and reducing the possibility of instability and unexplainability that may result from blindly using a large number of unverified objects; on the other hand, a random number of target objects are automatically randomly selected from the second object set, and the user does not need to explicitly select the target objects to obtain the artistically enhanced images. The entire generation process is completely imperceptible to the user, thereby simplifying the operation and improving the user's operation experience.

The following describes the application of the method for generating an image provided by the embodiments of the present disclosure in an actual scenario. The scenario of generating the images based on prompt information and artist names (corresponding to the above-mentioned target objects) is used as an example for illustration.

Text-to-Image Generation, as an important part of AIGC, has received increasing attention and application with the continuous improvement and breakthrough of its generation quality. The users only need to describe the expected content through the text (i.e., prompt information), and the text-to-image generation model may generate the high-quality image content that meets the semantic requirements of the prompt information. A common technique for improving the generation effect is to use the artist names in the prompt information. Since the text-to-image generation model is trained based on a large amount of training data including image-text pairs, and these training data include works of various artists, the trained text-to-image generation model can learn the mapping relationship between the artist names and their works, so that when the prompt information includes a certain artist name, the text-to-image generation model may correspondingly generate styles and contents similar to that artist's works, thereby achieving the purpose of improving the generation effect.

In related arts, users with some experience in text-to-image generation often add some commonly used artist names when composing prompts (i.e., prompt information), so that the text generation model may correspondingly generate images with styles and contents similar to those of the artists, thereby achieving the purpose of improving the generation effect. However, these artist names are mainly obtained through users' community experience, manual organization, etc., and there are very limited artists. In the process of text-to-image generation, repeated use of these artists, although improving the image generation effect, seriously affects the diversity of the image generation results. At the same time, some online text-to-image websites provide more artist names for users to use, but the users are not familiar with the style and content of each artist. Blind selection may instead make the generation results not as expected, bringing instability and unexplainability.

The embodiments of the present disclosure provide a method for generating an image. A large number of candidate artist names (corresponding to the above-mentioned candidate object set) are extracted from a large amount of prompt data, a high-quality artist name set (corresponding to the above-mentioned first object set) that can effectively improve the generation effect without affecting the semantic requirements of the original prompt information is screened out through a pre-trained model and quantitative evaluation metrics (corresponding to the above-mentioned score values and cross-modal similarities), and the artist name set can be used to improve the image generation effect, which can solve the limitations of using only a small number of manually verified artist names to improve the generation effect, and the instability and unexplainability that may result from blindly using a large number of unverified artist names.

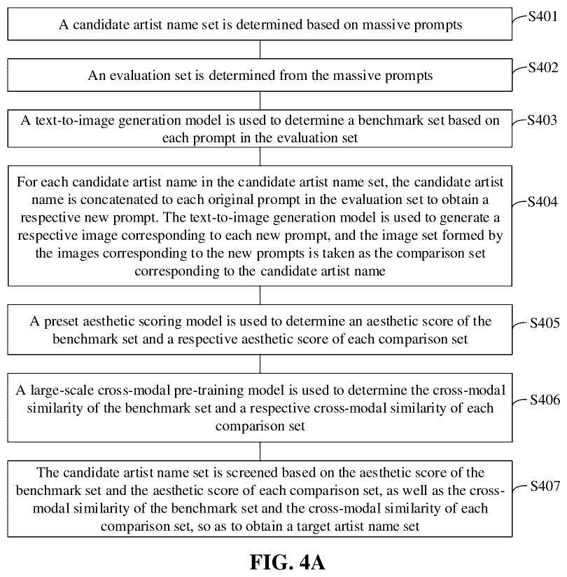

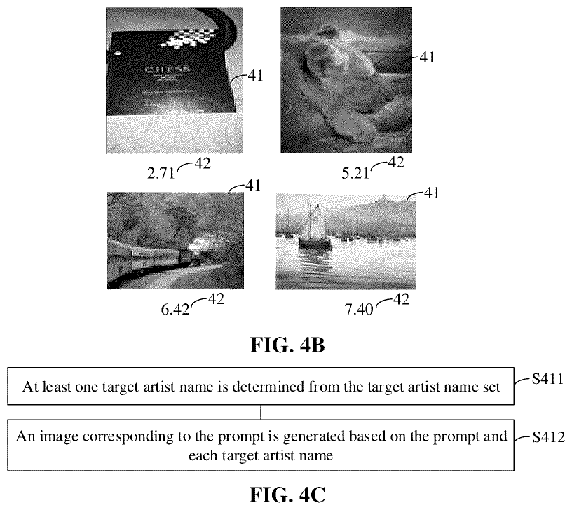

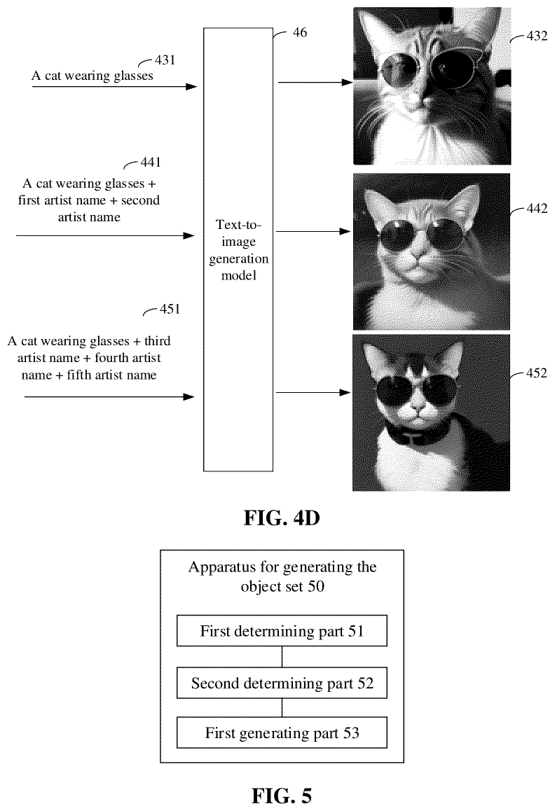

The implementation process of the method for generating an image provided by the embodiments of the present disclosure is described below from two stages: a screening stage and a use stage.
1. The screening stage mainly screens the candidate artist name set (corresponding to the above-mentioned candidate object set) to obtain a target artist name set (corresponding to the above-mentioned first image set). FIG. 4A is a third schematic diagram of an implementation process of a method for generating an object set according to an embodiment of the present disclosure. As shown in FIG. 4A, the method includes operations S401 to S407.

At S401, a candidate artist name set is determined based on massive prompts.

Here, different from the related art that mainly relies on manual organization, in order to obtain candidate artist names as many and comprehensive as possible, the present disclosure obtains massive prompt records from multiple most widely used online text-to-image websites and prompt resource integration websites. Each prompt record includes identifier information, a prompt, image attribute information, a random seed, etc. The prompt in each prompt record is obtained from the massive prompt records to form a first prompt set. In order to improve the quality of the prompts, prompts that are too long or too short are deleted from the first prompt set to form a second prompt set. A named entity recognition model is used to identify each prompt in the second prompt set, so as to delete prompts that do not include person names from the second prompt set, thereby forming the candidate artist name set. If manual processing is performed on the artists name set one by one (e.g., checking each artist's works through a search engine and determining whether to retain the artist based on personal perceptual judgment, or testing its effect on a text-to-image generation model, etc.,), a lot of time and manpower will be consumed. In contrast, the use of a fully automated processing flow and a pre-trained model to complete the screening work through quantitative evaluation metrics is more efficient and the results are more reliable.

At S402, an evaluation set (corresponding to the above-mentioned prompt information set) is determined from the massive prompts.

Here, since the second prompt set contains a large number of prompts, it is not feasible to screen the artist name set on the complete second prompt set. Therefore, multiple rounds of screening work can be performed. In each round, a small number of prompts (e.g., 100) are randomly selected from the second prompt set as the evaluation set.

At S403, a text-to-image generation model is used to determine a benchmark set (corresponding to the above-mentioned first image set) based on each prompt in the evaluation set.

Here, for each prompt in the evaluation set, a text-to-image generation model (e.g., Stable Diffusion) is used to generate an image (corresponding to the above-mentioned first image) corresponding to each prompt, and the obtained image set is taken as the benchmark set.

At S404, for each candidate artist name in the candidate artist name set, the candidate artist name is concatenated to each original prompt in the evaluation set to obtain a respective new prompt (corresponding to the above-mentioned second prompt information). The text-to-image generation model is used to generate a respective image (corresponding to the above-mentioned second image) corresponding to each new prompt, and the image set formed by the images corresponding to the new prompts is taken as the comparison set (corresponding to the above-mentioned second image set) corresponding to the candidate artist name.

Here, in order to verify and evaluate the impact of each artist name in the artist name set on effect of the text-to-image generation, each artist name is concatenated to each original prompt in the evaluation set, and then the text-to-image generation is performed. The obtained corresponding image set is taken as the comparison set. For example, assuming that the artist name set in this round includes K candidate artist names, K comparison sets will be produced, and the comparison sets include an equal number of images. In implementation, by calculating the results of the benchmark set and each comparison set on different evaluation metrics, the effect of each artist name on the text-to-image generation is quantitatively analyzed.

At S405, a preset aesthetic scoring model is used to determine an aesthetic score of the benchmark set (corresponding to the above-mentioned first score value) and a respective aesthetic score of each comparison set (corresponding to the above-mentioned second score value).

Here, generally, the result of the text-to-image generation should be as beautiful as possible, which have strong artistic expression and appeal, and can bring aesthetic pleasure to viewers to make the viewers willing to share it with others. However, the judgment of the beauty is a very subjective task, and different people often have different understandings and judgment criterias for beauty. But under the premise of sufficient data volume, it is still possible to rely on the model to learn a relatively reliable, stable, and accurate aesthetic scoring capability. In the present disclosure, an aesthetic scoring model trained based on the SAC dataset is used to calculate the aesthetic score of each image in the benchmark set and the aesthetic score of each image in each comparison set. The average of the aesthetic scores of the images in the benchmark set is taken as the aesthetic score A of the benchmark set, and the average of the aesthetic scores of the images in the comparison set is taken as the aesthetic score A_k of the comparison set, thereby determining whether using a certain artist name can effectively improve the aesthetic quality of the image.

FIG. 4B is a schematic diagram of an aesthetic score value of an image according to an embodiment of the present disclosure. As shown in FIG. 4B, an aesthetic scoring model is used to score each image 41 to obtain a score value 42 corresponding to the each image 41. In implementation, for images 41 of different qualities, score values 42 with discrimination can be given. The higher the score value 42, the higher the aesthetic value of the image 41.

At S406, a large-scale cross-modal pre-training model is used to determine the cross-modal similarity of the benchmark set (corresponding to the above-mentioned first cross-modal similarity) and a respective cross-modal similarity of each comparison set (corresponding to the above-mentioned second cross-modal similarity).

Here, using the artist names in the prompts can improve the quality, but sometimes it can also seriously affect the original semantics. For example, the original prompt is “a boy”, but a certain artist's works are mainly landscapes. After concatenating the artist name to the original prompt, the generation result may not contain a boy at all, but instead generate a landscape image. This situation changes the original semantics and will seriously affect the user's text-to-image generation experience. In implementation, the artist names should not cause changes or impacts on the original semantics. To calculate the cross-modal similarity between the generated image and the original prompt, the present disclosure uses the CLIP to map both the original prompt and the generated image into a fixed-length vector representation, and then calculates the cosine similarity between the original prompt and the generated image. The higher the similarity, the more the content of the generated image conforms to the semantic requirements of the original prompt. In implementation, by using the CLIP, the cross-modal similarity of each image in the benchmark set and the cross-modal similarity of each image in each comparison set are calculated. The average of the cross-modal similarities of the images in the benchmark set is taken as the cross-modal similarity C of the benchmark set, and the average of the cross-modal similarities of the images in the comparison set is taken as the cross-modal similarity C_k of the comparison set, thereby determining whether using a certain artist name will affect the semantics of the original prompt.

At S407, the candidate artist name set is screened based on the aesthetic score of the benchmark set and the aesthetic score of each comparison set, as well as the cross-modal similarity of the benchmark set and the cross-modal similarity of each comparison set, so as to obtain a target artist name set (corresponding to the above-mentioned first object set).

Here, it is determined whether the aesthetic score A_i of the i-th comparison set is greater than the aesthetic score A of the benchmark set. If A i is less than A, it is indicated that after using the i-th artist name, and the overall aesthetic score of the generated image does not increase but decrease. Therefore, the artist name needs to be deleted in this round of optimization. Otherwise, the artist name needs to be retained in this round of optimization. Here, i is not greater than K, and K is the total number of artist names in the artist name set.

It is determined whether the cross-modal similarity C_i of the i-th comparison set is greater than the cross-modal similarity C of the benchmark set. If C_i minus C is less than a set threshold, it is indicated that after using the i-th artist name, the overall cross-modal similarity of the generated image decreases, and the generated content is more semantically inconsistent with the original prompt. Therefore, the artist name needs to be deleted in this round of optimization. Otherwise, the artist name needs to be retained in this round of optimization.

In some embodiments, the aesthetic score of the comparison set and the aesthetic score of the benchmark set may be judged first. In a case that the aesthetic score of the comparison set is not less than the aesthetic score of the benchmark set, the cross-modal similarity of the comparison set and the cross-modal similarity of the benchmark set are judged.

In some embodiments, the cross-modal similarity of the comparison set and the cross-modal similarity of the benchmark set may be judged first. In a case that the cross-modal similarity of the comparison set minus the cross-modal similarity of the benchmark set is less than the set threshold, the aesthetic score of the comparison set and the aesthetic score of the benchmark set are judged.

If no artist name is deleted in this round of optimization, the optimization work is stopped. Otherwise, the above operations S402 to S407 are executed to perform the next round of optimization until no artist name is deleted in a certain round of optimization, and the finally obtained artist name set is taken as an effective, reliable, and high-quality target artist name set (corresponding to the above-mentioned first object set).
2. The use stage mainly uses the target artist name set to generate the images. FIG. 4C is a second schematic diagram of an implementation process of a method for generating an image according to an embodiment of the present disclosure. As shown in FIG. 4C, the method includes operations S411 to S412.

At S411, at least one target artist name (corresponding to the above-mentioned target object) is determined from the target artist name set (corresponding to the above-mentioned second object set);

Here, in some embodiment applications, several (e.g., 1 to 3) artist names are randomly selected from the target artist name set as each target artist name.

At S412, an image corresponding to the prompt is generated based on the prompt and each target artist name.

Here, each target artist name is concatenated to the prompt input by the user, and the text-to-image generation model is used to generate the image corresponding to the prompt. The entire generation process is completely imperceptible to the user. The user can obtain artistically enhanced images without explicitly manually selecting the artist names. Since the artist name set includes multiple artist names and the number of randomly selected names is not fixed, compared with the repetition of generation results in content and style caused by using only a small number of artist names, the generated image results are richer and more diverse, and the generation effect can be significantly improved both in detail quality and overall aesthetics.

FIG. 4D is a schematic diagram of an image generated based on a prompt according to an embodiment of the present disclosure. As shown in FIG. 4D, after the user inputs a prompt 431, the following operations are performed.

If the target artist name is empty (i.e., the artistic enhancement is not used), the text-to-image generation model 46 can be used to generate an image 432 corresponding to the prompt 431.

If the target artist names include a first artist name (John Fabian Carlson) and a second artist name (Charles Harold Davis), after concatenating each target artist name to the prompt 431, a new prompt 441 is formed. The text-to-image generation model 46 can be used to generate an image 442 corresponding to the prompt 441, and the image 442 can be taken as the image corresponding to the prompt 431. The image 442 includes styles and contents similar to those of the two artists “John Fabian Carlson” and “Charles Harold Davis”.

If the target artist names include a third artist name (Ilya Kuvshinov), a fourth artist name (Frans Koppelaar), and a fifth artist name (Harriet Backer), after concatenating each target artist name to the prompt 431, a new prompt 451 may be formed. Then, the text-to-image generation model 46 may be used to generate an image 452 corresponding to the prompt 451, and the image 452 can be taken as the image corresponding to the prompt 431. The image 452 includes styles and contents similar to those of the three artists “Ilya Kuvshinov”, “Frans Koppelaar”, and “Harriet Backer”.

The method provided by the embodiments of the present disclosure at least has the following beneficial effects:
1) A large number of artist names may be extracted from massive prompt records. Compared with the fact that the repeated use of a small number of available artist names obtained based on manual organization leads to repetitiveness and convergence of the generated contents, since the optimized artist name set contains a large number of artist names and the number of randomly selected artist names is not fixed, richer and more diverse artistic enhancement effects can be achieved.
2) An aesthetic scoring model and a CLIP model trained based on a large amount of labeled data are used to calculate the evaluation metrics of different image sets. Compared with the fact that the screening performed mainly based on the personal perceptual judgment results in a limited number of screening results with subjectivity and unreliability, the evaluation criteria and screening criteria are quantifiable, comparable, and interpretable, making the screening results more numerous, objective, and reliable.

Those skilled in the art may understand that in the above method of the specific embodiments, the writing order of the operations does not imply a strict execution order that limits the implementation process, and the specific execution order of the operations should be determined by the functions and possible internal logics thereof.

Based on the above embodiments, an embodiment of the present disclosure provides an apparatus for generating an object set. FIG. 5 is a structural diagram of an apparatus for generating an object set according to an embodiment of the present disclosure. As shown in FIG. 5, the apparatus 50 for generating the object set includes a first determining part 51, a second determining part 52 and a first generating part 53.

The first determining part 51 is configured to determine a first image set based on a prompt information set. Each first image in the first image set corresponds to a respective piece of first prompt information in the prompt information set.

The second determining part 52 is configured to, for each candidate object in a candidate object set, determine a second image set matching the candidate object based on the candidate object and the prompt information set. The second image set includes at least one second image. Each of the at least one second image corresponds to a respective piece of first prompt information. The candidate object is configured to characterize an image style.

The first generating part 53 is configured to determine a first object set from the candidate object set based on attribute information of the first image set and attribute information of a respective second image set corresponding to each candidate object.

In some embodiments, the first generating part 53 is further configured to: for each candidate object in the candidate object set, determine a detection result of the candidate object based on the attribute information of the first image set and the attribute information of the second image set corresponding to the candidate object, and determine the first object set from the candidate object set based on a respective detection result of each candidate object. The detection result of the candidate object indicates whether the candidate object needs to be deleted from the candidate object set.

In some embodiments, the attribute information of the first image set includes a first score value, and the attribute information of the second image set includes a second score value. The first generating part 53 is further configured to: determine the first score value of the first image set based on a respective score value of each first image in the first image set; determine the second score value of the second image set based on a respective score value of each second image in the second image set; and determine the detection result of the candidate object based on the first score value and the second score value.

In some embodiments, the first generating part 53 is further configured to perform at least one of following operations. In a case that the second score value is less than the first score value, a first detection result is taken as the detection result of the candidate object, herein the first detection result indicates that the candidate object needs to be deleted from the candidate object set. In a case that the second score value is not less than the first score value, a second detection result is taken as the detection result of the candidate object, herein the second detection result indicates that the candidate object does not need to be deleted from the candidate object set.

In some embodiments, the attribute information of the first image set includes a first cross-modal similarity, and the attribute information of the second image set includes a second cross-modal similarity. The first generating part 53 is further configured to: determine the first cross-modal similarity corresponding to the first image set based on each first image in the first image set and first prompt information corresponding to the each first image; determine the second cross-modal similarity corresponding to the second image set based on each second image in the second image set and first prompt information corresponding to the each second image; and determine the detection result of the candidate object based on the first cross-modal similarity and the second cross-modal similarity.

In some embodiments, the first generating part 53 is further configured to: for each first image in the first image set, determine a first similarity between the first image and the first prompt information corresponding to the first image; and determine the first cross-modal similarity corresponding to the first image set based on each first similarity.

In some embodiments, the first generating part 53 is further configured to: for each second image in the second image set, determine a second similarity between the second image and the first prompt information corresponding to the second image; and determine the second cross-modal similarity corresponding to the second image set based on each second similarity.

In some embodiments, the first generating part 53 is further configured to: determine a third cross-modal similarity based on the first cross-modal similarity and the second cross-modal similarity; in a case that the third cross-modal similarity is less than a similarity threshold, take a first detection result as the detection result of the candidate object; and in a case that the third cross-modal similarity is not less than the similarity threshold, take a second detection result as the detection result of the candidate object.

In some embodiments, the first generating part 53 is further configured to perform at least one of: in a case that a respective detection result of each candidate object is a second detection result, take the candidate object set as the first object set; or in a case that detection results of candidate objects include at least one first detection result, delete a respective candidate object corresponding to each of the at least one first detection result from the candidate object set, and take the candidate object set subject to the deletion as a new candidate object set; determine a new first image set based on a new prompt information set; for each candidate object in the new candidate object set, determine a new second image set matching the candidate object based on the new prompt information set and the candidate object; determine the first object set from the new candidate object set based on attribute information of the new first image set and attribute information of a respective new second image set corresponding to each candidate object.

In some embodiments, the second determining part 52 is further configured to: for each piece of first prompt information in the prompt information set, determine second prompt information based on the candidate object and the first prompt information, and determine a second image matching the candidate object based on the second prompt information.

The description of the above embodiments of the apparatus for generating the object set is similar to the description of the above embodiments of the method for generating the object set, and has similar beneficial effects as the embodiments of the method for generating the object set. For technical details not disclosed in the apparatus embodiments of the present disclosure for generating the object set, reference can be made to the description of the method embodiments of the present disclosure for generating the object set.

In the embodiments of the present disclosure and other embodiments, the expression “part” may refer to part of a circuit, part of a processor, part of a program or software, etc. The expression “part” may also refer to a unit or a module, or may be non-modular.

Based on the above embodiments, an embodiment of the present disclosure provides an apparatus for generating an image. FIG. 6 is a structural diagram of an apparatus for generating an image according to an embodiment of the present disclosure. As shown in FIG. 6, the apparatus 60 for generating the image includes a third determining part 61 and a second generating part 62.

The third determining part 61 is configured to determine at least one target object from a second object set. The second object set is obtained according to any one of the above-mentioned methods for generating the object set.

The second generating part 62 is configured to generate an image corresponding to prompt information based on the prompt information and each of the at least one target object.

The description of the above embodiments of the apparatus for generating the image is similar to the description of the above embodiments of the method for generating the image, and has similar beneficial effects as the embodiments of the method for generating the image. For technical details not disclosed in the apparatus embodiments of the present disclosure for generating the image, reference can be made to the description of the method embodiments of the present disclosure for generating the image.

It should be noted that, in the embodiments of the present disclosure, if the above methods are implemented in the form of a software function module and sold or used as an independent product, the software function module may also be stored in a computer-readable storage medium. Based on such understanding, the technical solutions of the embodiments of the present disclosure, in essence or the part contributing to the related art, may be embodied in the form of a software product. The software product may be stored in a storage medium and includes several instructions for enabling an electronic device (which may be a personal computer, a server, or a network device, etc.) to execute all or part of the methods described in the various embodiments of the present disclosure. The aforementioned storage medium may include various mediums that can store program codes, such as a U disk, a mobile hard disk, a Read Only Memory (ROM), a magnetic disk, or an optical disk. Thus, the embodiments of the present disclosure are not limited to any specific combination of hardware and software.

An embodiment of the present disclosure provides an electronic device, which includes a processor and a memory. The memory is configured to store a computer program executable on the processor, and the processor is configured to execute the computer program to implement the above-mentioned methods.

An embodiment of the present disclosure provides a computer-readable storage medium having stored thereon a computer program. The computer program, when executed by a processor, implements the above-mentioned methods. The computer-readable storage medium may be transitory or non-transitory.

An embodiment of the present disclosure provides a computer program product. The computer program product includes a non-transitory computer-readable storage medium having stored thereon a computer program. The computer program, when read and executed by a computer, implements some or all operations of the above-mentioned methods. The computer program product may be implemented by hardware, software, or a combination thereof in some embodiments. In an optional embodiment, the computer program product may be embodied as, for example, a computer storage medium. In another optional embodiment, the computer program product is embodied as a software product, such as a Software Development Kit (SDK), etc.

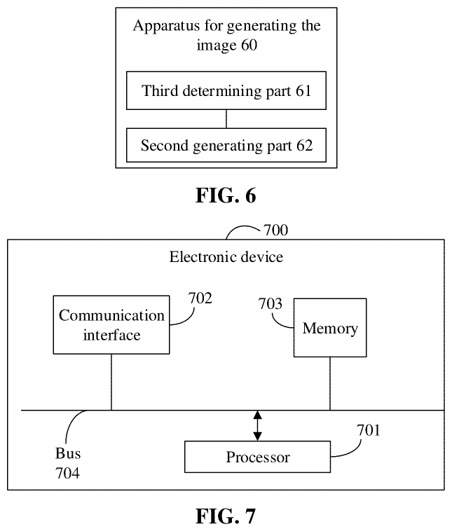

It should be noted that FIG. 7 is a schematic diagram of a hardware entity of an electronic device according to an embodiment of the present disclosure. As shown in FIG. 7, the hardware entity of the electronic device 700 includes a processor 701, a communication interface 702 and a memory 703.

The processor 701 generally controls the overall operation of the electronic device 700.

The communication interface 702 may enable the electronic device to communicate with other terminals or servers via a network.

The memory 703 is configured to store instructions and applications executable by the processor 701, and may also cache data to be processed or already processed by the processor 701 and various parts of the electronic device 700 (e.g., image data, audio data, voice communication data and video communication data). The memory 703 may be implemented by a flash memory (FLASH) or a Random Access Memory (RAM). Data transmission between the processor 701, the communication interface 702 and the memory 703 may be performed via a bus 704.

It should be noted here that the descriptions of the above storage medium and device embodiments are similar to the descriptions of the above method embodiments, and have similar beneficial effects as the method embodiments. For technical details not disclosed in the storage medium and device embodiments of the present disclosure, reference can be made to the descriptions of the method embodiments of the present disclosure.

It should be understood that the mention of “one embodiment” or “an embodiment” throughout the specification means that a particular feature, structure, or characteristic described in connection with the embodiment is included in at least one embodiment of the present disclosure. Therefore, the appearances of the phrases “in one embodiment” or “in an embodiment” throughout the specification are not necessarily all referring to the same embodiment. Furthermore, the particular features, structures, or characteristics may be combined in one or more embodiments in any suitable manner. It should be understood that, in the various embodiments of the present disclosure, the sequence numbers of the above-mentioned processes do not imply an order of execution, which should be determined by their functions and internal logic, and should not constitute any limitation to the implementation process of the embodiments of the present disclosure. The serial numbers of the embodiments of the present disclosure are for description only and do not represent the advantages or disadvantages of the embodiments.

It should be noted that in the present disclosure, the terms “comprising”, “including”, or any other variation thereof, are intended to cover a non-exclusive inclusion, such that a process, method, article, or apparatus that includes a list of elements includes not only those elements but also other elements not explicitly listed, or may include elements inherent to such process, method, article, or apparatus. Without more constraints, an element defined by the phrase “comprising a . . . ” does not exclude the presence of additional identical elements in the process, method, article, or apparatus that includes the element.

In the several embodiments provided by the present disclosure, it should be understood that the disclosed apparatus and method may be implemented in other ways. The apparatus embodiments described above are illustrative. For example, the division of the units is only a logical function division. In actual implementation, there may be another division manner. For example, multiple units or components may be combined or may be integrated into another system, or some features may be ignored or not executed. In addition, the coupling, direct coupling, or communication connection between the various components shown or discussed may be through some interfaces, and the indirect coupling or communication connection between devices or units may be electrical, mechanical, or in other forms.

The units described as separate parts may or may not be physically separate. The parts displayed as units may or may not be physical units. That is, the units may be located in one place, or may be distributed on multiple network units. Some or all of the units may be selected according to actual requirements to achieve the objectives of the solutions of the embodiments.

In addition, the functional units in the embodiments of the present disclosure may be integrated into one processing unit, or each unit may exist alone as a unit, or two or more units may be integrated into one unit. The above integrated unit may be implemented in the form of hardware, or in the form of hardware plus software functional units.

Those skilled in the art may understand that all or part of the operations for implementing the above method embodiments may be completed by hardware related to program instructions. The above mentioned program may be stored in a computer-readable storage medium. When the program is executed, the operations including the above method embodiments are performed. The above mentioned storage medium may include various medium that can store program codes, such as a mobile storage device, a Read Only Memory (ROM), a magnetic disk, or an optical disk.

Alternatively, if the above integrated unit of the present disclosure is implemented in the form of a software functional module and sold or used as an independent product, the software functional module may also be stored in a computer-readable storage medium. Based on such understanding, the technical solutions of the present disclosure, in essence or the part contributing to the related art, may be embodied in the form of a software product. The computer software product is stored in a storage medium and includes several instructions for enabling an electronic device (which may be a personal computer, a server, or a network device, etc.) to execute all or part of the methods described in the various embodiments of the present disclosure. The above mentioned storage medium may include various media that can store program codes, such as a mobile storage device, a ROM, a magnetic disk, or an optical disk.

The foregoing descriptions are merely specific implementations of the present disclosure. However, the scope of protection of the present disclosure is not limited thereto. Any change or substitution easily conceived by those skilled in the art within the technical scope disclosed by the present disclosure shall be covered within the scope of protection of the present disclosure.

### INDUSTRIAL APPLICABILITY

Embodiments of the present disclosure provide an object set and image generation method and apparatus, an electronic device, a storage medium, a computer program and a computer program product. The object set and image generation method includes the following operations. A first image set is determined based on a prompt information set. Each first image in the first image set corresponds to a respective piece of first prompt information in the prompt information set. For each candidate object in a candidate object set, a second image set matching the candidate object is determined based on the candidate object and the prompt information set. The second image set includes at least one second image. Each of the at least one second image corresponds to a respective piece of first prompt information, and the candidate object is configured to characterize an image style. A first object set is determined from the candidate object set based on attribute information of the first image set and attribute information of a respective second image set corresponding to each candidate object. In the embodiments of the present disclosure, by using the attribute information of the first image set and attribute information of a respective second image set corresponding to each candidate object, the candidate object set is automatically screened to obtain the first object set. Compared with methods such as personal perceptual judgment, community experience and manual organization, the quantity of objects increases and the time required to obtain the objects is shortened, so that the cost of obtaining the objects is reduced. In addition, the reliability and accuracy of the obtained objects are improved. Furthermore, subsequently generating images using the first object set enables the images to have richer and more diverse enhancement effects, thereby reducing the limitations of using only a small number of manually experienced objects to enhance generated images, and reducing the possibility of instability and unexplainability that may result from blindly using a large number of unverified objects.

1. A method for generating an object set, comprising:
determining a first image set based on a prompt information set, wherein each first image in the first image set corresponds to a respective piece of first prompt information in the prompt information set;
for each candidate object in a candidate object set, determining a second image set matching the candidate object based on the candidate object and the prompt information set, wherein the second image set comprises at least one second image, each of the at least one second image corresponds to a respective piece of first prompt information, and the candidate object is configured to characterize an image style; and
determining a first object set from the candidate object set based on attribute information of the first image set and attribute information of a respective second image set corresponding to each candidate object.

2. The method of claim 1, wherein determining the first object set from the candidate object set based on the attribute information of the first image set and the attribute information of a respective second image set corresponding to each candidate object comprises:
for each candidate object in the candidate object set, determining a detection result of the candidate object based on the attribute information of the first image set and the attribute information of the second image set corresponding to the candidate object, wherein the detection result of the candidate object indicates whether the candidate object needs to be deleted from the candidate object set; and
determining the first object set from the candidate object set based on a respective detection result of each candidate object.

3. The method of claim 2, wherein the attribute information of the first image set comprises a first score value, and the attribute information of the second image set comprises a second score value,
wherein determining the detection result of the candidate object based on the attribute information of the first image set and the attribute information of the second image set corresponding to the candidate object comprises:
determining the first score value of the first image set based on a respective score value of each first image in the first image set;
determining the second score value of the second image set based on a respective score value of each second image in the second image set; and
determining the detection result of the candidate object based on the first score value and the second score value.

4. The method of claim 3, wherein determining the detection result of the candidate object based on the first score value and the second score value comprises at least one of:
in a case that the second score value is less than the first score value, taking a first detection result as the detection result of the candidate object, wherein the first detection result indicates that the candidate object needs to be deleted from the candidate object set; or
in a case that the second score value is not less than the first score value, taking a second detection result as the detection result of the candidate object, wherein the second detection result indicates that the candidate object does not need to be deleted from the candidate object set.

5. The method of claim 2, wherein the attribute information of the first image set comprises a first cross-modal similarity, and the attribute information of the second image set comprises a second cross-modal similarity,
wherein determining the detection result of the candidate object based on the attribute information of the first image set and the attribute information of the second image set corresponding to the candidate object comprises:
determining the first cross-modal similarity corresponding to the first image set based on each first image in the first image set and first prompt information corresponding to the each first image;
determining the second cross-modal similarity corresponding to the second image set based on each second image in the second image set and first prompt information corresponding to the each second image; and
determining the detection result of the candidate object based on the first cross-modal similarity and the second cross-modal similarity.

6. The method of claim 5, wherein determining the first cross-modal similarity corresponding to the first image set based on each first image in the first image set and the first prompt information corresponding to the each first image comprises:
for each first image in the first image set, determining a first similarity between the first image and the first prompt information corresponding to the first image; and
determining the first cross-modal similarity corresponding to the first image set based on each first similarity;
wherein determining the second cross-modal similarity corresponding to the second image set based on each second image in the second image set and the first prompt information corresponding to each second image comprises:
for each second image in the second image set, determining a second similarity between the second image and the first prompt information corresponding to the second image; and
determining the second cross-modal similarity corresponding to the second image set based on each second similarity.

7. The method of claim 5, wherein determining the detection result of the candidate object based on the first cross-modal similarity and the second cross-modal similarity comprises:
determining a third cross-modal similarity based on the first cross-modal similarity and the second cross-modal similarity;
in a case that the third cross-modal similarity is less than a similarity threshold, taking a first detection result as the detection result of the candidate object; and
in a case that the third cross-modal similarity is not less than the similarity threshold, taking a second detection result as the detection result of the candidate object.

8. The method of claim 2, wherein determining the first object set from the candidate object set based on a respective detection result of each candidate object comprises at least one of:
in a case that a respective detection result of each candidate object is a second detection result, taking the candidate object set as the first object set; or
in a case that detection results of candidate objects comprise at least one first detection result, deleting a respective candidate object corresponding to each of the at least one first detection result from the candidate object set, and taking the candidate object set subject to the deletion as a new candidate object set; determining a new first image set based on a new prompt information set; for each candidate object in the new candidate object set, determining a new second image set matching the candidate object based on the new prompt information set and the candidate object; determining the first object set from the new candidate object set based on attribute information of the new first image set and attribute information of a respective new second image set corresponding to each candidate object.

9. The method of claim 1, wherein determining the second image set matching the candidate object based on the candidate object and the prompt information set comprises:
for each piece of first prompt information in the prompt information set, determining second prompt information based on the candidate object and the first prompt information, and determining a second image matching the candidate object based on the second prompt information.

10. A method for generating an image, comprising:
determining at least one target object from a second object set, wherein the second object set is obtained according to the method of claim 1; and
generating an image corresponding to prompt information based on the prompt information and each of the at least one target object.

11.-12. (canceled)

13. An electronic device, comprising a processor and a memory, wherein the memory is configured to store a computer program executable in the processor, and the processor is configured to execute the computer program to:
determine a first image set based on a prompt information set, wherein each first image in the first image set corresponds to a respective piece of first prompt information in the prompt information set;
for each candidate object in a candidate object set, determine a second image set matching the candidate object based on the candidate object and the prompt information set, wherein the second image set comprises at least one second image, each of the at least one second image corresponds to a respective piece of first prompt information, and the candidate object is configured to characterize an image style; and
determine a first object set from the candidate object set based on attribute information of the first image set and attribute information of a respective second image set corresponding to each candidate object.

14. A non-transitory computer-readable storage medium having stored thereon a computer program, which, when executed by a processor, implements the following operations:
determining a first image set based on a prompt information set, wherein each first image in the first image set corresponds to a respective piece of first prompt information in the prompt information set;
for each candidate object in a candidate object set, determining a second image set matching the candidate object based on the candidate object and the prompt information set, wherein the second image set comprises at least one second image, each of the at least one second image corresponds to a respective piece of first prompt information, and the candidate object is configured to characterize an image style; and
determining a first object set from the candidate object set based on attribute information of the first image set and attribute information of a respective second image set corresponding to each candidate object.

15.-16. (canceled)

17. The electronic device of claim 13, wherein the processor is further configured to execute the computer program to:
for each candidate object in the candidate object set, determine a detection result of the candidate object based on the attribute information of the first image set and the attribute information of the second image set corresponding to the candidate object, wherein the detection result of the candidate object indicates whether the candidate object needs to be deleted from the candidate object set; and
determine the first object set from the candidate object set based on a respective detection result of each candidate object.

18. The electronic device of claim 17, wherein the attribute information of the first image set comprises a first score value, and the attribute information of the second image set comprises a second score value,
wherein the processor is further configured to execute the computer program to:
determine the first score value of the first image set based on a respective score value of each first image in the first image set;
determine the second score value of the second image set based on a respective score value of each second image in the second image set; and
determine the detection result of the candidate object based on the first score value and the second score value.

19. The electronic device of claim 18, wherein the processor is further configured to execute the computer program to:
in a case that the second score value is less than the first score value, take a first detection result as the detection result of the candidate object, wherein the first detection result indicates that the candidate object needs to be deleted from the candidate object set; or
in a case that the second score value is not less than the first score value, take a second detection result as the detection result of the candidate object, wherein the second detection result indicates that the candidate object does not need to be deleted from the candidate object set.

20. The electronic device of claim 17, wherein the attribute information of the first image set comprises a first cross-modal similarity, and the attribute information of the second image set comprises a second cross-modal similarity,
wherein the processor is further configured to execute the computer program to:
determine the first cross-modal similarity corresponding to the first image set based on each first image in the first image set and first prompt information corresponding to the each first image;
determine the second cross-modal similarity corresponding to the second image set based on each second image in the second image set and first prompt information corresponding to the each second image; and
determine the detection result of the candidate object based on the first cross-modal similarity and the second cross-modal similarity.

21. The electronic device of claim 20, wherein the processor is further configured to execute the computer program to:
for each first image in the first image set, determine a first similarity between the first image and the first prompt information corresponding to the first image; and
determine the first cross-modal similarity corresponding to the first image set based on each first similarity;
for each second image in the second image set, determine a second similarity between the second image and the first prompt information corresponding to the second image; and
determine the second cross-modal similarity corresponding to the second image set based on each second similarity.

22. The electronic device of claim 20, wherein the processor is further configured to execute the computer program to:
determine a third cross-modal similarity based on the first cross-modal similarity and the second cross-modal similarity;
in a case that the third cross-modal similarity is less than a similarity threshold, take a first detection result as the detection result of the candidate object; and
in a case that the third cross-modal similarity is not less than the similarity threshold, take a second detection result as the detection result of the candidate object.

23. The electronic device of claim 17, wherein the processor is further configured to execute the computer program to:
in a case that a respective detection result of each candidate object is a second detection result, take the candidate object set as the first object set; or
in a case that detection results of candidate objects comprise at least one first detection result, delete a respective candidate object corresponding to each of the at least one first detection result from the candidate object set, and take the candidate object set subject to the deletion as a new candidate object set; determine a new first image set based on a new prompt information set; for each candidate object in the new candidate object set, determine a new second image set matching the candidate object based on the new prompt information set and the candidate object; determine the first object set from the new candidate object set based on attribute information of the new first image set and attribute information of a respective new second image set corresponding to each candidate object.

24. The electronic device of claim 13, wherein the processor is further configured to execute the computer program to:
for each piece of first prompt information in the prompt information set, determine second prompt information based on the candidate object and the first prompt information, and determine a second image matching the candidate object based on the second prompt information.
